(19) United States
(12) Patent Application Publication
(10) Pub. No.: US 2025/0101161 A1
(43) Pub. Date: Mar. 27, 2025

(54) STATISTICAL COPOLYMERS COMPRISING VINYLBENZOCYCLOBUTANE AND METHODS OF MAKING THE SAME

(71) Applicants: Bridgestone Corporation, Chuo-ku (JP); Bridgestone Americas Tire Operations, LLC, Nashville, TN (US)

(72) Inventors: Terrence Eugene Hogan, Uniontown, OH (US); Walter Anthony Salamant, Akron, OH (US)

(73) Assignees: Bridgestone Corporation, Chuo-ku, TK (JP); Bridgestone Americas Tire Operations, LLC, Nashville, TN (US)

(21) Appl. No.: 18/897,419

(22) Filed: Sep. 26, 2024

Related U.S. Application Data
(60) Provisional application No. 63/585,695, filed on Sep. 27, 2023.

(51) Int. Cl. C08F 236/10; B60C 1/00

(52) U.S. Cl. CPC C08F 236/10; B60C 1/0016; C08F 2800/20; C08F 2810/20

(57) ABSTRACT

Embodiments of the present disclosure are directed to polymers, wherein the polymers include a conjugated diene and from about 0.02 wt. % to about 2.0 wt. % of vinylbenzocyclobutane, based on a total weight of the polymer. The polymer is a crosslinkable statistical copolymer of conjugated diene and vinylbenzocyclobutane monomer units.

### CROSS-REFERENCE TO RELATED APPLICATIONS

The present specification claims the benefit of U.S. Provisional Application Ser. No. 63/585,695 filed Sep. 27, 2023 and entitled “Statistical Copolymers Comprising Vinylbenzocyclobutane and Methods of Making the Same,” the entirety of which is incorporated by reference herein.

### TECHNICAL FIELD

Embodiments of the present disclosure are generally related to statistical copolymers, and are specifically related to statistical copolymers comprising vinylbenzocyclobutane monomer units.

### BACKGROUND

Rubber formulations comprising natural rubbers and/or synthetic rubbers are commonly used in tire applications, for example tire tread. However, sufficient and even crosslinking of the polymers during curing may be difficult due to uneven distribution of crosslink points throughout the individual polymer chains of the rubbers.

Accordingly, a continual need exists for improved polymers having a more even distribution of crosslink points, thereby improving the crosslinking density and crosslink distribution of the cured polymer.

### SUMMARY

Embodiments of the present disclosure are directed to crosslinkable statistical copolymers comprising conjugated diene and vinylbenzocyclobutane, which have improved crosslink density and crosslink distribution when cured.

According to one embodiment, a polymer is provided. The polymer includes a conjugated diene and about 0.02 wt. % to about 2.0 wt. % of vinylbenzocyclobutane, based on the total weight of the polymer. The polymer is a crosslinkable statistical copolymer of conjugated diene and vinylbenzocyclobutane monomer units.

According to another embodiment, a method of making a polymer is provided. The method includes polymerizing via anionic polymerization a conjugated diene monomer and vinylbenzocyclobutane monomer in the presence of an anionic initiator and a randomizing component to produce a crosslinkable statistical copolymer.

According to another embodiment, a polymer is provided. The polymer includes a conjugated diene and from 1 to 15 vinylbenzocyclobutane monomer units. Greater than or equal to about 50% of polymer chains have from 0.5 to 3 vinylbenzocyclobutane monomer units on the end of the polymer chain. The remainder of vinylbenzocyclobutane monomer units are statistically distributed throughout the polymer chain.

Additional features and advantages of the embodiments described herein will be set forth in the detailed description which follows, and in part will be readily apparent to those skilled in the art from that description or recognized by practicing the embodiments described herein, including the detailed description which follows, and the claims.

### DETAILED DESCRIPTION

Embodiments of the present disclosure are directed to polymers. The polymers may comprise a conjugated diene and from about 0.02 wt. % to about 2.0 wt. % of vinylbenzocyclobutane, hereinafter referred to as “VBCB.” The polymer may be a crosslinkable statistical copolymer of conjugated diene and VBCB monomer units. In other embodiments, the polymer may further comprise vinyl aromatic monomer units and the polymer may be a crosslinkable statistical copolymer of conjugated diene, vinyl aromatic, and VBCB monomer units.

The disclosure should not be construed as limited to the embodiments set forth herein. Rather, these embodiments are provided so that this disclosure will be thorough and complete, and will fully convey the subject matter to those skilled in the art.

### Definitions

Unless otherwise defined, all technical and scientific terms used herein have the same meaning as commonly understood by one of ordinary skill in the art. The terminology used in the disclosure herein is for describing particular embodiments only and is not intended to be limiting.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used in the specification and the appended claims, the singular forms “a,” “an,” and “the” are intended to include the plural forms as well, unless the context clearly indicates otherwise. Thus, for example, reference to “a” component includes aspects having two or more such components, unless the context clearly indicates otherwise.

The term “statistical copolymer,” as described herein, refers to a copolymer in which individual monomer units are arranged along the polymer chain following a statistical distribution. Statistical copolymers are copolymers in which the sequential distribution of the monomeric units obeys known statistical laws; for example, the monomer sequence distribution may follow Markovian statistics of zeroth (Bernoullian), first, second, or higher order. Kinetically, the elementary processes leading to the formation of a statistical sequence of monomeric units do not necessarily proceed with equal a priori probability. These processes can lead to various types of sequence distribution comprising those in which the arrangement of monomeric units tends toward alternation, tends toward clustering of like units, or exhibits no ordering tendency at all. In simple binary copolymerization, the nature of this sequence distribution can be indicated by the numerical values of a function either of the reactivity ratios or of the related run number.

The term “crosslinkable,” as described herein, refers to the ability of a polymer chain to form crosslinks between itself and other polymer chains.

The term “crosslink point,” as described herein refers to points along a polymer chain that may form crosslinks between polymer chains.

“Number average molecular weight Mn” and “weight average molecular weight Mw,” as described herein, are determined by gel permeation chromatography using universal calibration with polystyrene standards and corrected using the Mark-Houwink constants for styrene-butadiene rubber (SBR) (also known as poly(butadiene-co-styrene)).

Glass transition temperature T_{g}, as described herein, is measured by differential scanning calorimetry

As discussed hereinabove copolymers may lack sufficient and even crosslinking during curing due to uneven distribution of crosslink points throughout the individual polymer chains of the rubbers.

Disclosed herein are statistical copolymers, which mitigate the aforementioned problems. Specifically, the polymers disclosed herein have a statistical distribution of conjugated diene monomer and vinylbenzocyclobutane monomer along a polymer chain, which results in a polymer that, when cured, may have relatively more even crosslinking between polymer chains when compared to polymers that do not have a statistical distribution of monomer units. In particular, vinylbenzocyclobutane monomer units may form crosslinks with both other vinylbenzocyclobutane monomer units and the unsaturation in the backbone of the polymer. Thus, the dispersal of vinylbenzocyclobutane monomer units throughout the entire length of the statistical copolymer chains may improve both the crosslink density and the distribution of crosslinks throughout the cured copolymer. This dispersal may be achieved by performing the polymerization of the conjugated diene monomer and the vinylbenzocyclobutane monomer in the presence of a randomizing component.

### Polymer

The polymers disclosed herein may generally be described as comprising a conjugated diene and vinylbenzocyclobutane.

The polymer comprises VBCB. Without being bound by theory, it is believed that VBCB monomer units within a polymer chain may form crosslinks with other VBCB monomer units on other polymer chains as well as form crosslinks with unsaturation in the polymeric backbone of other polymer chains. Thus, the dispersal of VBCB monomer units throughout the entire length of the statistical copolymer chains may improve both the crosslink density and the distribution of crosslinks throughout the cured copolymer. These crosslinks may provide the polymer with desired mechanical properties once the polymer is cured.

In embodiments, the polymer may comprise VBCB in an amount, based on the total weight of the polymer, greater than or equal to about 0.02 wt. %, greater than or equal to about 0.1 wt. %, greater than or equal to about 0.25 wt. %, greater than or equal to about 0.5 wt. %, greater than or equal to about 0.75 wt. %, or even greater than or equal to about 1.0 wt. %. In embodiments the polymer may comprise VBCB in an amount, based on a total weight of the polymer, less than or equal to about 2.0 wt. %, less than or equal to about 1.75 wt. %, less than or equal to about 1.5 wt. %, or even less than or equal to about 1.25 wt. %. In embodiments, the polymer may comprise VBCB in an amount, based on a total weight of the polymer, from about 0.02 wt. % to about 2.0 wt. %, from about 0.02 wt. % to about 1.75 wt. %, from about 0.02 wt. % to about 1.5 wt. %, from about 0.02 wt. % to about 1.25 wt. %, from about 0.1 wt. % to about 2.0 wt. %, from about 0.1 wt. % to about 1.75 wt. %, from about 0.1 wt. % to about 1.5 wt. %, from about 0.1 wt. % to about 1.25 wt. %, from about 0.25 wt. % to about 2.0 wt. %, from about 0.25 wt. % to about 1.75 wt. %, from about 0.25 wt. % to about 1.5 wt. %, from about 0.25 wt. % to about 1.25 wt. %, from about 0.5 wt. % to about 2.0 wt. %, from about 0.5 wt. % to about 1.75 wt. %, from about 0.5 wt. % to about 1.5 wt. %, from about 0.5 wt. % to about 1.25 wt. %, from about 0.75 wt. % to about 2.0 wt. %, from about 0.75 wt. % to about 1.75 wt. %, from about 0.75 wt. % to about 1.5 wt. %, from about 0.75 wt. % to about 1.25 wt. %, from about 1.0 wt. % to about 2.0 wt. %, from about 1.0 wt. % to about 1.75 wt. %, from about 1.0 wt. % to about 1.5 wt. %, or even from about 1.0 wt. % to about 1.25 wt. %, or any and all sub-ranges formed from any of these endpoints. Without being bound by theory it is believed that a statistical copolymer that comprises less than 0.02 wt. % of VBCB may not have the desired crosslink density and distribution after curing. It is also believed that VBCB in an amount greater than 2.0 wt. %, may negatively impact the tensile properties of the cured rubber formulation, such as, for example, the elongation of the rubber formulation.

In embodiments, the polymer may comprise from 1 to 15 VBCB monomer units per polymer chain. In embodiments, the polymer may comprise greater than or equal to 1, greater than or equal to 2, greater than or equal to 3, greater than or equal to 4, greater than or equal to 5, greater than or equal to 6, or even greater than or equal to 7 VBCB monomer units per polymer chain. In embodiments, the polymer may comprise less than or equal to 15, less than or equal to 14, less than or equal to 13, less than or equal to 12, less than or equal to 11, less than or equal to 10, or even less than or equal to 9 VBCB monomer units per polymer chain. In embodiments, the polymer may comprise from 1 to 15, from 1 to 14, from 1 to 13, from 1 to 12, from 1 to 11, from 1 to 10, from 1 to 9, from 2 to 15, from 2 to 14, from 2 to 13, from 2 to 12, from 2 to 11, from 2 to 10, from 2 to 9, from 3 to 15, from 3 to 14, from 3 to 13, from 3 to 12, from 3 to 11, from 3 to 10, from 3 to 9, from 4 to 15, from 4 to 14, from 4 to 13, from 4 to 12, from 4 to 11, from 4 to 10, from 4 to 9, from 5 to 15, from 5 to 14, from 5 to 13, from 5 to 12, from 5 to 11, from 5 to 10, from 5 to 9, from 6 to 15, from 6 to 14, from 6 to 13, from 6 to 12, from 6 to 11, from 6 to 10, from 6 to 9, from 7 to 15, from 7 to 14, from 7 to 13, from 7 to 12, from 7 to 11, from 7 to 10, or even from 7 to 9, or any and all sub-ranges formed from any of these endpoints, VBCB monomer units per chain.

In embodiments, the polymer may have at least 1 VBCB monomer unit at an end of the polymer chain. In embodiments, the polymer may have at least 2, at least 3, or even at least 4 VBCB monomer units at the end of the polymer chain. In embodiments, the polymer may have from 1 to 4, from 1 to 3, from 1 to 2, from 2 to 4, from 2 to 3, or even from 3 to 4, or any and all sub-ranges formed from any of these endpoints, VBCB monomer units at the end of the polymer chain.

In embodiments, greater than or equal to about 50% of polymer chains in the polymer may have from 0.5 to 3 VBCB monomer units on the end of the polymer. In embodiments, greater than or equal to about 55%, greater than or equal to about 60%, greater than or equal to about 65%, greater than or equal to about 70%, greater than or equal to about 75%, greater than or equal to about 80%, greater than or equal to about 85%, or even greater than or equal to about 90% of polymer chains may have from 0.5 to 3 VBCB monomer units on the end of the polymer chain. In embodiments greater than or equal to about 50% of polymer chains may have from 0.5 to 3, from 0.5 to 2.5, from 0.5 to 2, from 0.5 to 1.5, from 0.5 to 1, from 1 to 3, from 1 to 2.5, from 1 to 2, from 1 to 1.5, from 1.5 to 3, from 1.5 to 2.5, from 1.5 to 2, from 2 to 3, from 2 to 2.5, or even from 2.5 to 3, or any and all sub-ranges formed from any of these endpoints, VBCB monomer units on the end of the polymer chain. In such embodiments, the remainder of VBCB monomer units may be statistically distributed throughout the polymer chain.

The polymers disclosed herein comprise a conjugated diene. Without being bound by theory, it is believed that the VBCB monomer units may form crosslinks with the carbon-carbon double bonds of the conjugated diene monomer units. This may allow for increased crosslink density, as the VBCB monomer units may be able to form more crosslinks when compared to polymers that do not comprise conjugated diene monomer units.

In embodiments the conjugated diene is selected from the group consisting of 1,3-butadiene, isoprene, 1,3-pentadiene, 1,3-hexadiene, 2,3-dimethyl-1,3-butadiene, 2-ethyl-1,3-butadiene, 2-methyl-1,3-pentadiene, 3-methyl-1,3-pentadiene, 4-methyl-1,3-pentadiene, 2,4-hexadiene, 1,3-cyclopentadiene, 1,3-cyclohexadiene, 1,3-cycloheptadiene, 1,3-cyclooctadiene, and combinations thereof. In embodiments, the conjugated diene may be 1,3-butadiene.

In embodiments, the polymer may comprise from about 50 wt. % to about 99 wt. % of conjugated diene, based on the total weight of the polymer. In embodiments, the polymer may comprise conjugated diene in an amount, based on a total weight of the polymer, greater than or equal to about 50 wt. %, greater than or equal to about 55 wt. %, greater than or equal to about 60 wt. %, or even greater than or equal to about 65 wt. %. In embodiments, the polymer may comprise conjugated diene in an amount, based on a total weight of the polymer, less than or equal to about 99 wt. %, less than or equal to about 95 wt. %, less than or equal to about 90 wt. %, less than or equal to about 85 wt. %, or even less than or equal to about 80 wt. %. In embodiments, the polymer may comprise conjugated diene in an amount, based on a total weight of the polymer, from about 50 wt. % to about 99 wt. %, from about 50 wt. % to about 95 wt. %, from about 50 wt. % to about 90 wt. %, from about 50 wt. % to about 85 wt. %, from about 50 wt. % to about 80 wt. %, from about 55 wt. % to about 99 wt. %, from about 55 wt. % to about 90 wt. %, from about 55 wt. % to about 85 wt. %, from about 55 wt. % to about 80 wt. %, from about 60 wt. % to about 99 wt. %, from about 60 wt. % to about 95 wt. %, from about 60 wt. % to about 90 wt. %, from about 60 wt. % to about 85 wt. %, from about 60 wt. % to about 80 wt. %, from about 65 wt. % to about 99 wt. %, from about 65 wt. % to about 95 wt. %, from about 65 wt. % to about 90 wt. %, from about 65 wt. % to about 85 wt. %, or even from about 65 wt. % to about 80 wt. %, or any and all sub-ranges formed from any of these endpoints.

In embodiments, the polymer may further comprise a vinyl aromatic. In such embodiments, the polymer may be a crosslinkable statistical copolymer of conjugated diene, vinyl aromatic, and VBCB monomer units. Without being bound by theory, it is believed that the presence of a vinyl aromatic monomer may increase the glass transition of the polymer, when compared to polymer without a vinyl aromatic monomer. Increasing the glass transition temperature of a polymer may improve the wet and dry traction of a tire made using a rubber formulation that comprises that polymer.

In embodiments, the vinyl aromatic may be selected from the group consisting of styrene, alpha-methyl styrene, p-methylstyrene, o-methylstyrene, p-butyl styrene, vinylnapthalene, p-tertbutylstyrene, 4-vinylbiphenyl, 2-vinylnapthalene, 9-vinylanthracene, vinyl catechol, and combinations thereof. In embodiments, the vinyl aromatic may be styrene.

In embodiments, the polymer may comprise from about 5 wt. % to about 50 wt. % of the vinyl aromatic, based on the total weight of the polymer. In embodiments, the polymer may comprise vinyl aromatic in an amount, based on the total weight of the polymer, greater than or equal to about 5 wt. %, greater than or equal to about 10 wt. %, greater than or equal to about 15 wt. %, or even greater than or equal to about 20 wt. %. In embodiments the polymer may comprise vinyl aromatic in an amount, based on the total weight of the polymer, less than or equal to about 50 wt. %, less than or equal to about 45 wt. %, less than or equal to about 40 wt. %, less than or equal to about 35 wt. %, or even less than or equal to about 30 wt. %. In embodiments the polymer may comprise vinyl aromatic in an amount, based on the total weight of the polymer, from about 5 wt. % to about 50 wt. %, from about 5 wt. % to about 45 wt. %, from about 5 wt. % to about 40 wt. %, from about 5 wt. % to about 35 wt. %, from about 5 wt. % to about 30 wt. %, from about 10 wt. % to about 50 wt. %, from about 10 wt. % to about 45 wt. %, from about 10 wt. % to about 40 wt. %, from about 10 wt. % to about 35 wt. %, from about 10 wt. % to about 30 wt. %, from about 15 wt. % to about 50 wt. %, from about 15 wt. % to about 45 wt. %, from about 15 wt. % to about 40 wt. %, from about 15 wt. % to about 35 wt. %, from about 15 wt. % to about 30 wt. %, from about 20 wt. % to about 50 wt. %, from about 20 wt. % to about 45 wt. %, from about 20 wt. % to about 40 wt. %, from about 20 wt. % to about 35 wt. %, or even from about 20 wt. % to about 30 wt. %, or any and all sub-ranges formed from any of these endpoints.

In embodiments, the polymer may have a weight average molecular weight M_{w} of from about 1.0×10⁵ g/mol to about 2.0×10⁶ g/mol. In embodiments, the polymer may have a weight average molecular weight M_{w} of greater than or equal to about 1.0×10⁵ g/mol, greater than or equal to about 2.5×10⁵ g/mol, greater than or equal to about 5.0×10⁵ g/mol, or even greater than or equal to about 7.5×10⁵ g/mol. In embodiments, the polymer may have a weight average molecular weight M_{w} of less than or equal to about 2.0×10⁶ g/mol, less than or equal to about 1.75×10⁶ g/mol, less than or equal to about 1.5×10⁶ g/mol, or even less than or equal to about 1.25×10⁶ g/mol. In embodiments the polymer may have a weight average molecular weight M_{w} of from about 1.0×10⁵ g/mol to about 2.0×10⁶ g/mol, from about 1.0×10⁵ g/mol to about 1.75×10⁶ g/mol, from about 1.0×10⁵ g/mol to about 1.5×10⁶ g/mol, from about 1.0×10⁵ g/mol to about 1.25×10⁶ g/mol, from about 2.5×10⁵ g/mol to about 2.0×10⁶ g/mol, from about 2.5×10⁶ g/mol to about 1.75×10⁶ g/mol, from about 2.5×10⁵ g/mol to about 1.5×10⁶ g/mol, from about 2.5×10⁵ g/mol to about 1.25×10⁶ g/mol, from about 5.0×10⁵ g/mol to about 2.0×10⁶ g/mol, from about 5.0×10⁵ g/mol to about 1.75×10⁶ g/mol, from about 5.0×10⁵ g/mol to about 1.5×10⁶ g/mol, from about 5.0×10⁵ g/mol to about 1.25×10⁶ g/mol, from about 7.5×10⁵ g/mol to about 2.0×10⁶ g/mol, from about 7.5×10⁵ g/mol to about 1.75×10⁶ g/mol, from about 7.5×10⁵ g/mol to about 1.5×10⁶ g/mol, or even from about 7.5×10⁵ g/mol to about 1.25×10⁶ g/mol, or any and all sub-ranges formed from any of these endpoints. Without being bound by theory, it is believed that a polymer having a weight average molecular weight of less than about 1.0×10⁵ g/mol may be more difficult to process than a polymer having a weight average molecular weight of from about 1.0×10⁵ g/mol to about 2.0×10⁶ g/mol because of an increased risk of cold flow. It is also believed that a polymer having a weight average molecular weight of greater than about 2.0×10⁶ may be more difficult to process than a polymer having a weight average molecular weight of from about 1.0×10⁵ g/mol to about 2.0×10⁶ g/mol because of the increased viscosity of the polymer.

In embodiments, the polymer may have a number average molecular weight Mₙ of from about 1.0×10⁵ g/mol to about 2.0×10⁶ g/mol. In embodiments, the polymer may have a number average molecular weight Mₙ of greater than or equal to about 1.0×10⁵ g/mol, greater than or equal to about 2.5×10⁵ g/mol, greater than or equal to about 5.0×10⁵ g/mol, or even greater than or equal to about 7.5×10⁵ g/mol. In embodiments, the polymer may have a number average molecular weight Mₙ of less than or equal to about 2.0×10⁶ g/mol, less than or equal to about 1.75×10⁶ g/mol, less than or equal to about 1.5×10⁶ g/mol, or even less than or equal to about 1.25×10⁶ g/mol. In embodiments the polymer may have a number average molecular weight Mₙ of from about 1.0×10⁵ g/mol to about 2.0×10⁶ g/mol, from about 1.0×10⁵ g/mol to about 1.75×10⁶ g/mol, from about 1.0×10⁵ g/mol to about 1.5×10⁶ g/mol, from about 1.0×10⁵ g/mol to about 1.25×10⁶ g/mol, from about 2.5×10⁵ g/mol to about 2.0×10⁶ g/mol, from about 2.5×10⁶ g/mol to about 1.75×10⁶ g/mol, from about 2.5×10⁵ g/mol to about 1.5×10⁶ g/mol, from about 2.5×10⁵ g/mol to about 1.25×10⁶ g/mol, from about 5.0×10⁵ g/mol to about 2.0×10⁶ g/mol, from about 5.0×10⁵ g/mol to about 1.75×10⁶ g/mol, from about 5.0×10⁵ g/mol to about 1.5×10⁶ g/mol, from about 5.0×10⁵ g/mol to about 1.25×10⁶ g/mol, from about 7.5×10⁵ g/mol to about 2.0×10⁶ g/mol, from about 7.5×10⁵ g/mol to about 1.75×10⁶ g/mol, from about 7.5×10⁵ g/mol to about 1.5×10⁶ g/mol, or even from about 7.5×10⁵ g/mol to about 1.25×10⁶ g/mol, or any and all sub-ranges formed from any of these endpoints.

In embodiments, the polymer may have a peak molecular weight Mₚ of from about 1.0×10⁵ g/mol to about 2.0×10⁶ g/mol. In embodiments, the polymer may have a peak molecular weight Mₚ of greater than or equal to about 1.0×10⁵ g/mol, greater than or equal to about 2.5×10⁵ g/mol, greater than or equal to about 5.0×10⁵ g/mol, or even greater than or equal to about 7.5×10⁵ g/mol. In embodiments, the polymer may have a peak molecular weight Mₚ of less than or equal to about 2.0×10⁶ g/mol, less than or equal to about 1.75×10⁶ g/mol, less than or equal to about 1.5×10⁶ g/mol, or even less than or equal to about 1.25×10⁶ g/mol. In embodiments the polymer may have a peak molecular weight Mₚ of from about 1.0×10⁵ g/mol to about 2.0×10⁶ g/mol, from about 1.0×10⁵ g/mol to about 1.75×10⁶ g/mol, from about 1.0×10⁵ g/mol to about 1.5×10⁶ g/mol, from about 1.0×10⁵ g/mol to about 1.25×10⁶ g/mol, from about 2.5×10⁵ g/mol to about 2.0×10⁶ g/mol, from about 2.5×10⁶ g/mol to about 1.75×10⁶ g/mol, from about 2.5×10⁵ g/mol to about 1.5×10⁶ g/mol, from about 2.5×10⁵ g/mol to about 1.25×10⁶ g/mol, from about 5.0×10⁵ g/mol to about 2.0×10⁶ g/mol, from about 5.0×10⁵ g/mol to about 1.75×10⁶ g/mol, from about 5.0×10⁵ g/mol to about 1.5×10⁶ g/mol, from about 5.0×10⁵ g/mol to about 1.25×10⁶ g/mol, from about 7.5×10⁵ g/mol to about 2.0×10⁶ g/mol, from about 7.5×10⁵ g/mol to about 1.75×10⁶ g/mol, from about 7.5×10⁵ g/mol to about 1.5×10⁶ g/mol, or even from about 7.5×10⁵ g/mol to about 1.25×10⁶ g/mol, or any and all sub-ranges formed from any of these endpoints.

In embodiments, the polymer may have a polydispersity (PDI) of less than or equal to 1.5, less than or equal to 1.4, less than or equal to 1.3, less than or equal to 1.2, or even less than or equal to 1.1.

In embodiments, the polymer may have a weight average molecular weight of incorporated conjugated diene monomers, incorporated vinyl aromatic monomers, or combinations thereof between VBCB monomer units of from about 10,000 g/mol to about 50,000 g/mol. In embodiments, the polymer may have a weight average molecular weight of conjugated diene monomers, incorporated vinyl aromatic monomers, or combinations thereof between VBCB monomer units of greater than or equal to about 10,000 g/mol, greater than or equal to about 15,000 g/mol, greater than or equal to about 20,000 g/mol, or even greater than or equal to 25,000 g/mol. In embodiments, the polymer may have a weight average molecular weight of conjugated diene monomers, incorporated vinyl aromatic monomers, or combinations thereof between VBCB monomer units of less than or equal to about 50,000 g/mol, less than or equal to about 45,000 g/mol, less than or equal to about 40,000 g/mol, or even less than or equal to about 35,000 g/mol. In embodiments, the polymer may have a weight average molecular weight of incorporated conjugated diene monomers, incorporated vinyl aromatic monomers, or combinations thereof between VBCB monomer units of from about 10,000 g/mol to about 50,000 g/mol, from about 10,000 g/mol to about 45,000 g/mol, from about 10,000 g/mol to about 40,000 g/mol, from about 10,000 g/mol to about 35,000 g/mol, from about 15,000 g/mol to about 50,000 g/mol, from about 15,000 g/mol to about 45,000 g/mol, from about 15,000 g/mol to about 40,000 g/mol, from about 15,000 g/mol to about 35,000 g/mol, from about 20,000 g/mol to about 50,000 g/mol, from about 20,000 g/mol to about 45,000 g/mol, from about 20,000 g/mol to about 40,000 g/mol, from about 20,000 g/mol to about 35,000 g/mol, from about 25,000 g/mol to about 50,000 g/mol, from about 25,000 g/mol to about 45,000 g/mol, from about 25,000 g/mol to about 40,000 g/mol, or even from about 25,000 g/mol to about 35,000 g/mol, or any and all sub-ranges formed from any of these endpoints. Without being bound by theory, it is believed that a weight average molecular weight of incorporated conjugated diene monomers, incorporated vinyl aromatic monomers, or combinations thereof between VBCB monomer units of less than about 10,000 g/mol may cause a rubber formulation to cure too tightly and may negatively impact the elongation of the cured rubber. It is also believed that a weight average molecular weight of incorporated conjugated diene monomers, incorporated vinyl aromatic monomers, or combinations thereof between VBCB monomer units of greater than about 50,000 g/mol may cause a rubber formulation to lack the desired crosslink density.

In embodiments, the polymer may have a glass transition temperature T_{g} of from about −100° C. to about −20° C. In embodiments, the polymer may have a glass transition temperature T_{g} of greater than or equal to about −100° C., greater than or equal to about −90° C., greater than or equal to about −80° C., or even greater than or equal to about −70° C. In embodiments, the polymer may have a glass transition temperature T_{g} of less than or equal to about −20° C., less than or equal to about −30° C., less than or equal to about −40° C., or even less than or equal to about −50° C. In embodiments the polymer may have a glass transition temperature T_{g} of from about −100° C. to about −20° C., from about −100° C. to about −30° C., from about −100° C. to about −40° C., from about −100 to about −50° C., from about −90° C. to about −20° C., from about −90° C. to about −30° C., from about −90° C. to about −40° C., from about −90° C. to about −50° C., from about −80° C. to about −20° C., from about −80° C. to about −30° C., from about −80° C. to about −40° C., from about −80° C. to about −50° C., from about −70° C. to about −20° C., from about −70° C. to about −30° C., from about −70° C. to about −40° C., or even from about −70° C. to about −50° C., or any and all sub-ranges formed from any of these endpoints. Without being bound by theory, it is believed that a glass transition temperature of greater than about −20° C. may negatively impact the snow and rolling resistance performance of a tire tread that incorporates the statistical copolymer.

In embodiments, the polymer may be curable by heating the polymer to a temperature of greater than or equal to 200° C., greater than or equal to 205° C., greater than or equal to 210° C., or even greater than or equal to 215° C. Without being bound by theory, it is believed that by heating the polymer to a temperature of greater than or equal to 200° C., the VBCB monomer units of a polymer chain may react with VBCB monomer units, conjugated diene monomer units, or both of other polymer chains to form crosslinks.

### Polymer Synthesis

In embodiments, the polymers of the present disclosure may be prepared using anionic polymerization, wherein the monomers are polymerized in the presence of an anionic initiator to produce polymer chains with a living end. In embodiments the polymer may be prepared by polymerizing via anionic polymerization a conjugated diene monomer and VBCB monomer in the presence of an anionic initiator and a randomizing component to produce a crosslinkable statistical copolymer.

In embodiments, the anionic initiator may be a hydrocarbyl lithium compound. In embodiments, the anionic initiator may comprise ethyl lithium, n-propyl lithium, isopropyl lithium, n-butyl lithium, sec-butyl lithium, tert-octyl lithium, n-decyl lithium, phenyl lithium, 2-naphthyl lithium, 2-butyl-phenyl lithium, 4-phenyl-butyl lithium, cyclohexyl lithium, cyclopentyl lithium, a reaction product of diisopropenylbenzene and butyl lithium, or combinations thereof. In some embodiments, the anionic initiator is n-butyl lithium.

In embodiments, the conjugated diene monomer may be selected from the group consisting of 1,3-butadiene, isoprene, 1,3-pentadiene, 1,3-hexadiene, 2,3-dimethyl-1,3-butadiene, 2-ethyl-1,3-butadiene, 2-methyl-1,3-pentadiene, 3-methyl-1,3-pentadiene, 4-methyl-1,3-pentadiene, 2,4-hexadiene, 1,3-cyclopentadiene, 1,3-cyclohexadiene, 1,3-cycloheptadiene, 1,3-cyclooctadiene, and combinations thereof.

In embodiments, the polymer may be prepared by also polymerizing vinyl aromatic monomer along with the conjugated diene monomer and VBCB monomer. In embodiments, the vinyl aromatic monomer is selected from the group consisting of styrene, alpha-methyl styrene, p-methylstyrene, o-methylstyrene, p-butyl styrene, vinylnapthalene, p-tertbutylstyrene, 4-vinylbiphenyl, 2-vinylnapthalene, 9-vinylanthracene, vinyl catechol, and combinations thereof.

In embodiments, the mole ratio of VBCB monomer to vinyl aromatic monomer and conjugated diene monomer may be from about 0.0005 to about 0.25. In embodiments, the mole ratio of VBCB monomer to vinyl aromatic monomer and conjugated diene monomer may be greater than or equal to about 0.0005, greater than or equal to about 0.005, greater than or equal to about 0.01, or even greater than or equal to about 0.05. In embodiments, the mole ratio of VBCB monomer to vinyl aromatic monomer and conjugated diene monomer may be less than or equal to about 0.25, less than or equal to about 0.20, less than or equal to about 0.15, or even less than or equal to about 0.1. In embodiments the mole ratio of VBCB monomer to vinyl aromatic monomer and conjugated diene monomer may be from about 0.0005 to about 0.25, from about 0.0005 to about 0.20, from about 0.0005 to about 0.15, from about 0.0005 to about 0.1, from about 0.005 to about 0.25, from about 0.005 to about 0.20, from about 0.005 to about 0.15, from about 0.005 to about 0.1, from about 0.01 to about 0.25, from about 0.01 to about 0.20, from about 0.01 to about 0.15, from about 0.01 to about 0.1, from about 0.05 to about 0.25, from about 0.05 to about 0.20, from about 0.05 to about 0.15, or even from about 0.05 to about 0.1, or any and all sub-ranges formed from any of these endpoints.

In embodiments, the polymerization may be performed in the presence of a randomizing component. Without being bound by theory, it is believed that the presence of a randomizing component may control the microstructure of the resulting polymer by controlling the rate of incorporation of each monomer into the growing polymer chain. The presence of a randomizing component during polymerization may therefore facilitate the formation of a statistical copolymer. In embodiments, the randomizing component may be selected from 2,2-ditetrahydrofurylpropane, meso-2,2-ditetrahydrofurylpropane, dimethoxybenzene, tetrahydrofuran, dimethoxyethane, diethylene glycol dibutyl ether, diethylene glycol dimethyl ether, triethylamine, pyridine, N-methylmorpholine, N,N,N′,N′-tetramethyl ethylenediamine, 1,2-dipiperidinoethane, potassium-t-amylate, potassium-t-butoxide, sodium-t-amylate, or combinations thereof.

### Rubber Compositions

In embodiments, the polymers of the present disclosure may be utilized in a rubber composition. In embodiments, the rubber composition may comprise the polymer. In embodiments, the rubber composition may also comprise reinforcing fillers, additives, oils (processing and extender), waxes, processing aids, antioxidants, tackifying resins, reinforcing resins, peptizers, and other components as would be known to those of skill in the art. In embodiments, the rubber composition may be utilized to form a tire tread.

### EXAMPLES

The polymers described herein will be further described in the following examples, which are not intended to restrict the polymers.

### Measurements

The number average molecular weight (Mn), weight average molecular weight (Mw), and the peak molecular weight (Mp) were determined by gel permeation chromatography using a TOSOH Esosec HLC-8320 GPC system and TOSOH TSKgel GMHxl-BS columns with THE as the solvent. The system was calibrated using polystyrene standards and corrected using the Mark-Houwink constants for styrene-butadiene rubber (SBR) (also known as poly(butadiene-co-styrene)).

The vinylbenzocyclobutane content, vinyl content, and styrene content were determined by ¹H-Nuclear Magnetic Resonance spectroscopy in chloroform-d at 25° C.

“Glass transition temperature T_{g}” was measured by differential scanning calorimetry. The differential scanning calorimetry method included a starting temperature of 23° C., heating to 200° C. at a 10° C./min ramp rate, cooling to −120° C., and reheating to 200° C. at a 10° C./min ramp rate.

### Example 1—Synthesis of Vinylbenzocyclobutane Copolymers

To an oven dried, nitrogen-purged 800 mL bottle, 119.8 g of hexanes, 35.3 g of a 34 wt. % solution of styrene in hexanes, 244.9 g of a 19.6 wt. % solution of 1,3-butadiene in hexanes, 0.09 mL of a 1.6 M solution of 2,2-ditetrahydrofurylpropane (80% meso isomer) in hexanes, and 0.25 mL of a 1.6 M solution of n-butyl lithium in hexanes were added. To produce Polymers 1-3, varying amounts of a 1 M solution of 4-vinylbenzocyclobutane (VBCB) in hexanes were also added. The amount of 4-vinylbenzocyclobutane for each reaction to produce Comparative Polymers A and B and Polymers 1-3 is shown in Table 1. After addition, the bottle was immersed in a 50° C. water bath and agitated. After 2 hours, the polymer solution was removed from the water bath and terminated with 0.1 mL of isopropanol. The solution was coagulated in an excess of isopropanol containing butylated hydroxytoluene. The properties of the produced polymers are shown in Table 2.

TABLE 1
Amount of 4-Vinylbenzocyclobutane Added

| | Comparative | Comparative | Polymer | Polymer | Polymer |
|---|---|---|---|---|---|
| | Polymer A | Polymer B | 1 | 2 | 3 |
| VBCB | 0 | 0 | 2 | 4 | 6 |
| 1(M), mL | | | | | |

TABLE 2
Properties of Synthesized Polymers

| | Comparative | Comparative | | | |
|---|---|---|---|---|---|
| | Polymer A | Polymer B | Polymer 1 | Polymer 2 | Polymer 3 |
| Mₚ (kg/mol) | 143.4 | 139.3 | 134.3 | 140.3 | 142.4 |
| Mₙ (kg/mol) | 141.2 | 137.2 | 131.2 | 137.4 | 138.8 |
| M_{w} (kg/mol) | 149.3 | 144.7 | 138.0 | 145.2 | 146.0 |
| Polydispersity | 1.06 | 1.06 | 1.05 | 1.06 | 1.05 |
| T_{g} (° C.) | −29.2 | −31.5 | −30.6 | −29.6 | −31.8 |
| wt. % Styrene | 20.9 | 21.0 | 20.6 | 20.8 | 20.9 |
| wt. % Vinyl | 60.9 | 59.2 | 59.0 | 60.1 | 58.5 |
| VBCB units per chain | 0 | 0 | 4.4 | 9.1 | 11.6 |
| Weight between | — | — | 30.8 | 15.4 | 12.2 |
| VBCB (kg/mol) | | | | | |

As shown in Table 2, VBCB monomer was successfully polymerized along with butadiene and styrene monomers into a copolymer as indicated by the NMR measured amounts of styrene, butadiene, and VBCB present in the polymer. The amount of VBCB per chain was calculated based on the wt. % of VBCB generated using ¹H NMR and the molecular weight of the polymers determined using GPC. While not wishing to be bound by theory, it is believed that the polymers formed on Example 1 are statistical copolymers because of the use of a randomizing component, 2,2-ditetrahydrofurylpropane (80% meso isomer), during polymerization

Embodiments may be further described with respect to the clauses below:
1. A polymer comprising: a conjugated diene; and from about 0.02 wt. % to about 2.0 wt. % of vinylbenzocyclobutane, based on a total weight of the polymer; wherein the polymer is a crosslinkable statistical copolymer of conjugated diene and vinylbenzocyclobutane monomer units.
2. The polymer of any preceding clause, wherein the conjugated diene is selected from the group consisting of 1,3-butadiene, isoprene, 1,3-pentadiene, 1,3-hexadiene, 2,3-dimethyl-1,3-butadiene, 2-ethyl-1,3-butadiene, 2-methyl-1,3-pentadiene, 3-methyl-1,3-pentadiene, 4-methyl-1,3-pentadiene, 2,4-hexadiene, 1,3-cyclopentadiene, 1,3-cyclohexadiene, 1,3-cycloheptadiene, 1,3-cyclooctadiene, and combinations thereof.
3. The polymer of any preceding clause, wherein the polymer comprises from about 50 wt. % to about 99 wt. % of the conjugated, diene based on the total weight of the polymer.
4. The polymer of any preceding clause, wherein the polymer has a weight average molecular weight of greater than or equal to about 1.0×10⁵ g/mol.
5. The polymer of any preceding clause, wherein the polymer has a weight average molecular weight of from about 1.0×10⁵ g/mol to about 2.0×10⁶ g/mol.
6. The polymer of any preceding clause, wherein the polymer comprises from 1 to 15 vinylbenzocyclobutane monomer units per polymer chain.
7. The polymer of any preceding clause, wherein the polymer further comprises a vinyl aromatic, and wherein the polymer is a crosslinkable statistical copolymer of conjugated diene, vinyl aromatic, and vinylbenzocyclobutane monomer units.
8. The polymer of any preceding clause, wherein the vinyl aromatic is selected from the group consisting of styrene, alpha-methyl styrene, p-methylstyrene, o-methylstyrene, p-butyl styrene, vinylnapthalene, p-tertbutylstyrene, 4-vinylbiphenyl, 2-vinylnapthalene, 9-vinylanthracene, vinyl catechol, and combinations thereof.
9. The polymer of any preceding clause, wherein the conjugated diene is 1,3-butadiene and the vinyl aromatic is styrene.
10. The polymer of any preceding clause, wherein the polymer has a weight average molecular weight of incorporated conjugated diene and vinyl aromatic monomer units between vinylbenzocyclobutane monomer units of from about 10,000 g/mol to about 50,000 g/mol.
11. The polymer of any preceding clause, wherein the polymer comprises from about 5 wt. % to about 50 wt. % of the vinyl aromatic, based on the total weight of the polymer.
12. The polymer of any preceding clause, wherein the polymer is formed by anionic polymerization.
13. The polymer of any preceding clause, wherein the polymer is curable by heating the polymer to a temperature of greater than or equal to 200° C.
14. The polymer of any preceding clause, wherein the polymer has a T_{g} of from about −100° C. to about −20° C.
15. The polymer of any preceding clause, wherein at least 1 vinylbenzocyclobutane monomer unit is at an end of the polymer chain.
16. A rubber composition comprising the polymer of any preceding clause.
17. A tire tread comprising the rubber composition of any preceding clause.
18. A method of making a polymer comprising: polymerizing via anionic polymerization a conjugated diene monomer and vinylbenzocyclobutane monomer in the presence of an anionic initiator and a randomizing component to produce a crosslinkable statistical copolymer.
19. The method of any preceding clause, herein the anionic initiator comprises a hydrocarbyl lithium compound.
20. The method of any preceding clause, wherein the anionic initiator comprises ethyl lithium, n-propyl lithium, isopropyl lithium, n-butyl lithium, sec-butyl lithium, tert-octyl lithium, n-decyl lithium, phenyl lithium, 2-naphthyl lithium, 2-butyl-phenyl lithium, 4-phenyl-butyl lithium, cyclohexyl lithium, cyclopentyl lithium, a reaction product of diisopropenylbenzene and butyl lithium, or combinations thereof.
21. The method of any preceding clause, wherein the anionic initiator is n-butyl lithium.
22. The method of any preceding clause, wherein the conjugated diene monomer is selected from the group consisting of 1,3-butadiene, isoprene, 1,3-pentadiene, 1,3-hexadiene, 2,3-dimethyl-1,3-butadiene, 2-ethyl-1,3-butadiene, 2-methyl-1,3-pentadiene, 3-methyl-1,3-pentadiene, 4-methyl-1,3-pentadiene, 2,4-hexadiene, 1,3-cyclopentadiene, 1,3-cyclohexadiene, 1,3-cycloheptadiene, 1,3-cyclooctadiene, and combinations thereof.
23. The method of any preceding clause, wherein the randomizing component is selected from 2,2-ditetrahydrofurylpropane, meso-2,2-ditetrahydrofurylpropane, dimethoxybenzene, tetrahydrofuran, dimethoxyethane, diethylene glycol dibutyl ether, diethylene glycol dimethyl ether, triethylamine, pyridine, N-methylmorpholine, N,N,N′,N′-tetramethyl ethylenediamine, 1,2-dipiperidinoethane, potassium-t-amylate, potassium-t-butoxide, sodium-t-amylate, or combinations thereof.
24. The method of any preceding clause, wherein a vinyl aromatic monomer is polymerized with the conjugated diene monomer and vinylbenzocyclobutane monomer.
25. The method of any preceding clause, wherein the vinyl aromatic monomer is selected from the group consisting of styrene, alpha-methyl styrene, p-methylstyrene, o-methylstyrene, p-butyl styrene, vinylnapthalene, p-tertbutylstyrene, 4-vinylbiphenyl, 2-vinylnapthalene, 9-vinylanthracene, vinyl catechol, and combinations thereof.
26. The method of any preceding clause, wherein the conjugated diene monomer is 1,3-butadiene and the vinyl aromatic monomer is styrene.
27. The method of any preceding clause, wherein the mole ratio of vinylbenzocyclobutane monomer to vinyl aromatic monomer and conjugated diene monomer is from about 0.0005 to about 0.25.
28. A polymer comprising: a conjugated diene; and from 1 to 15 vinylbenzocyclobutane monomer units; wherein greater than or equal to about 50% of polymer chains have from 0.5 to 3 vinylbenzocyclobutane monomer units on the end of the polymer chain; and wherein the remainder of vinylbenzocyclobutane monomer units are statistically distributed throughout the polymer chain.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects:

What is claimed is:

1. A polymer comprising:
a conjugated diene; and
from about 0.02 wt. % to about 2.0 wt. % of vinylbenzocyclobutane, based on a total weight of the polymer;
wherein the polymer is a crosslinkable statistical copolymer of conjugated diene and vinylbenzocyclobutane monomer units.

2. The polymer of claim 1, wherein the conjugated diene is selected from the group consisting of 1,3-butadiene, isoprene, 1,3-pentadiene, 1,3-hexadiene, 2,3-dimethyl-1,3-butadiene, 2-ethyl-1,3-butadiene, 2-methyl-1,3-pentadiene, 3-methyl-1,3-pentadiene, 4-methyl-1,3-pentadiene, 2,4-hexadiene, 1,3-cyclopentadiene, 1,3-cyclohexadiene, 1,3-cycloheptadiene, 1,3-cyclooctadiene, and combinations thereof.

3. The polymer of claim 1, wherein the polymer comprises from about 50 wt. % to about 99 wt. % of the conjugated, diene based on the total weight of the polymer.

4. The polymer of claim 1, wherein the polymer has a weight average molecular weight of greater than or equal to about 1.0×10⁵ g/mol.

5. The polymer of claim 1, wherein the polymer comprises from 1 to 15 vinylbenzocyclobutane monomer units per polymer chain.

6. The polymer of claim 1, wherein the polymer further comprises a vinyl aromatic, and wherein the polymer is a crosslinkable statistical copolymer of conjugated diene, vinyl aromatic, and vinylbenzocyclobutane monomer units, the vinyl aromatic being selected from the group consisting of styrene, alpha-methyl styrene, p-methylstyrene, o-methylstyrene, p-butyl styrene, vinylnapthalene, p-tertbutylstyrene, 4-vinylbiphenyl, 2-vinylnapthalene, 9-vinylanthracene, vinyl catechol, and combinations thereof.

7. The polymer of claim 6, wherein the polymer has a weight average molecular weight of incorporated conjugated diene and vinyl aromatic monomer units between vinylbenzocyclobutane monomer units of from about 10,000 g/mol to about 50,000 g/mol.

8. The polymer of claim 6, wherein the polymer comprises from about 5 wt. % to about 50 wt. % of the vinyl aromatic, based on the total weight of the polymer.

9. The polymer of claim 1, wherein the polymer is curable by heating the polymer to a temperature of greater than or equal to 200° C.

10. The polymer of claim 1, wherein the polymer has a T_{g} of from about −100° C. to about −20° C.

11. The polymer of claim 1, wherein at least 1 vinylbenzocyclobutane monomer unit is at an end of the polymer chain.

12. A rubber composition comprising the polymer of claim 1.

13. A tire tread comprising the rubber composition of claim 12.

14. A method of making a polymer comprising:
polymerizing via anionic polymerization a conjugated diene monomer and vinylbenzocyclobutane monomer in the presence of an anionic initiator and a randomizing component to produce a crosslinkable statistical copolymer.

15. The method of claim 14, wherein the anionic initiator comprises a hydrocarbyl lithium compound, the hydrocarbyl lithium compound comprising ethyl lithium, n-propyl lithium, isopropyl lithium, n-butyl lithium, sec-butyl lithium, tert-octyl lithium, n-decyl lithium, phenyl lithium, 2-naphthyl lithium, 2-butyl-phenyl lithium, 4-phenyl-butyl lithium, cyclohexyl lithium, cyclopentyl lithium, a reaction product of diisopropenylbenzene and butyl lithium, or combinations thereof.

16. The method of claim 14, wherein the conjugated diene monomer is selected from the group consisting of 1,3-butadiene, isoprene, 1,3-pentadiene, 1,3-hexadiene, 2,3-dimethyl-1,3-butadiene, 2-ethyl-1,3-butadiene, 2-methyl-1,3-pentadiene, 3-methyl-1,3-pentadiene, 4-methyl-1,3-pentadiene, 2,4-hexadiene, 1,3-cyclopentadiene, 1,3-cyclohexadiene, 1,3-cycloheptadiene, 1,3-cyclooctadiene, and combinations thereof.

17. The method of claim 14, wherein the randomizing component is selected from 2,2-ditetrahydrofurylpropane, meso-2,2,-ditetrahydrofurylpropane, dimethoxybenzene, tetrahydrofuran, dimethoxyethane, diethylene glycol dibutyl ether, diethylene glycol dimethyl ether, triethylamine, pyridine, N-methylmorpholine, N,N,N′,N′-tetramethyl ethylenediamine, 1,2-dipiperidinoethane, potassium-t-amylate, potassium-t-butoxide, sodium-t-amylate, or combinations thereof.

18. The method of claim 14, wherein a vinyl aromatic monomer is polymerized with the conjugated diene monomer and vinylbenzocyclobutane monomer, the vinyl aromatic monomer being selected from the group consisting of styrene, alpha-methyl styrene, p-methylstyrene, o-methylstyrene, p-butyl styrene, vinylnapthalene, p-tertbutylstyrene, 4-vinylbiphenyl, 2-vinylnapthalene, 9-vinylanthracene, vinyl catechol, and combinations thereof.

19. The method of claim 18, wherein the mole ratio of vinylbenzocyclobutane monomer to vinyl aromatic monomer and conjugated diene monomer is from about 0.0005 to about 0.25.

20. A polymer comprising:
a conjugated diene; and
from 1 to 15 vinylbenzocyclobutane monomer units;
wherein greater than or equal to about 50% of polymer chains have from 0.5 to 3 vinylbenzocyclobutane monomer units on the end of the polymer chain; and
wherein the remainder of vinylbenzocyclobutane monomer units are statistically distributed throughout the polymer chain.
